(19) United States
(12) Patent Application Publication
(10) Pub. No.: US 2011/0136956 A1
(43) Pub. Date: Jun. 9, 2011

(54) 1,4-CIS-POLYBUTADIENE FUNCTIONALIZED WITH ORGANOSULFUR COMPOUND FOR PREPARATION OF GOLF BALL CORE

(75) Inventors: Gwanghoon KWAG, Daejeon (KR); Hoo Chae KIM, Daejeon (KR); Seung Hwon LEE, Daejeon (KR); Hyun Jin KIM, Carlsbad, CA (US)

(73) Assignee: KOREA KUMHO PETROCHEMICAL CO., LTD., Seoul (KR)

(21) Appl. No.: 12/831,733

(22) Filed: Jul. 7, 2010

(30) Foreign Application Priority Data
Dec. 9, 2009 (KR) 10-2009-0121931

(51) Int. Cl. C08K 3/30; C08K 3/26; C08K 3/22; C08L 41/00; C08F 28/04

(52) U.S. Cl. 524/423; 524/426; 524/433; 524/547; 526/286

(57) ABSTRACT

Disclosed are 1,4-polybutadiene functionalized with an aromatic organosulfur compound, providing improved processability due to decreased Mooney viscosity and providing improved feel on hitting and flying performance due to decreased compression and increased restitution when used to prepare a golf ball core, and a composition for the preparation of a golf ball core including the same.

### CROSS-REFERENCE(S) TO RELATED APPLICATIONS

This application claims under 35 U.S.C. §119(a) the benefit of Korean Patent Application No. 10-2009-0121931 filed Dec. 9, 2009, the entire contents of which are incorporated herein by reference.

### BACKGROUND OF THE INVENTION

1. Field of the Invention

The present invention relates to 1,4-polybutadiene functionalized with an aromatic organosulfur compound, providing improved processability due to decreased Mooney viscosity and providing improved feel on hitting and flying performance due to decreased compression and increased restitution when used to prepare a golf ball core, and a composition for the preparation of a golf ball core including the same.

2. Description of Related Art

With regard to the manufacture of a golf ball, research has been focused on the composition of polybutadiene, the main component of a golf ball core, to improve restitution, flying performance and extrusion processability.

In general, golf balls are manufactured by using natural rubbers and plastics. The core is made by mixing synthetic rubber with chemicals, the intermediate layer is made from ionomers and chemicals, and the cover is made from elastomers such as Rabalon, Surlyn, urethane, etc. The golf ball core has a multi-layered structure of synthetic rubber and chemicals. In general, the golf balls are classified into two-, three- and four-piece balls depending on how many pieces they consist of.

U.S. Pat. Nos. 5,556,098 and 6,315,680 disclose the use of various elastomers in order to improve feel on hitting and flying performance.

Especially, U.S. Pat. No. 5,556,098 discloses a multi-layer golf ball comprising an intermediate layer formed of a polyester elastomer and a cover formed of an ionomer resin. However, the ball experiences degradation of durability after repeated hitting.

U.S. Pat. No. 6,315,680 introduces a mantle layer comprising a polyurethane resin and a polyester elastomer. However, because of the hard mantle, a dull feel is felt upon hitting. In addition, although an ionomer resin was used to improve flying performance, the clubhead may be broken when the ball is hit at the edge portion of the head. Further, the durability is not good.

U.S. Pat. No. 4,838,556 discloses that the coefficient of restitution of a golf ball may be improved by about 0.5 to 2.0% by preparing a golf ball core comprising an elastomer and an admixture of the elastomer with a metal salt of an unsaturated carboxylic acid, a radical initiator and a dispersing agent.

U.S. Pat. No. 4,852,884 discloses that inclusion of a metal carbamate accelerator in an elastomer comprising a metal salt of an unsaturated carboxylic acid, a radical initiator and a dispersing agent results in a high coefficient of restitution and high compression.

U.S. Pat. No. 4,844,471 discloses a golf ball with a coefficient of restitution as high as 0.809 while maintaining compression by including a dialkyl tin difatty acid in a golf ball core.

U.S. Pat. No. 4,546,980 discloses that use of two radical initiators having different half lives results in an improved coefficient of restitution of a golf ball over when only one radical initiator is used.

A golf ball is marked with compression, which indicates a measure of deformation in case a force is applied thereto. In general, the compression is indicated by the numbers printed on the ball surface in three colors—blue (80), red (90) and black (100). A larger number means a greater hardness. In general, a harder ball results in a longer flight distance because of larger resilience upon impact. To maximize the resilience, it is necessary to provide an adequate head speed. An increased hardness may result in improved flight distance of the golf ball being hit, however, golfers may experience an unsatisfactory feel while hitting the ball.

The spin rate of the golf ball is also an important factor in playing golf. Especially, since it is essential in short-distance approaches using backspin shots, golfers tend to prefer balls with, high spin rates. However, the easily controllable, high-spin balls have a relatively lower hardness and, thus, produce a shorter flight distance.

Numerous processes for preparing 1,4-cis-polybutadiene, a synthetic rubber usually used in the golf ball core, have been proposed.

Specifically, European Pat. Nos. 11,184 and 652,240 and U.S. Pat. Nos. 4,260,707 and 5,017,539 disclose a method of preparing 1,4-cis-polybutadiene using a rare earth element, whereby 1,4-cis-polybutadiene is prepared in a nonpolar solvent using a combination of a neodymium carboxylate, an alkylaluminum compound and a Lewis acid.

Great Britain Pat. No. 2,002,003 and U.S. Pat. No. 4,429,089 disclose a method of preparing 1,4-cis-polybutadiene using AlR₂X (R=hydrogen or alkyl, X=hydrogen, alkoxy or thioalkoxy), an alkylaluminum and a neodymium compound.

U.S. Pat. No. 4,699,962 discloses preparation of high 1,4-cis-polybutadiene using a catalyst prepared by reacting a neodymium hydride, a chloride compound and an electron donor ligand with an organoaluminum compound.

European Pat. No. 375,421 and U.S. Pat. No. 5,017,539 disclose preparation of high 1,4-cis-polybutadiene by aging a neodymium compound, an organic halide compound and an organoaluminum compound at a temperature below 0° C.

Examples of modifying the terminal groups of polybutadiene, such as epoxy, epoxy, siloxane, isocyanate, etc., utilizing the living property of neodymium catalyst are disclosed in WO 02/36615, European Pat. No. 713, 885, European Pat. No. 267,675 and U.S. Pat. No. 6,624,256.

In European Pat. No. 386,808, a catalyst comprising a neodymium carboxylate compound, an alkylaluminum compound and a halogen containing compound is utilized to polymerize high 1,4-cis-polybutadiene in a nonpolar solvent. Then, a trichlorophosphine compound (PCl₃) is added to improve processability by reducing low-temperature flowability. Here, Mooney viscosity increases considerably depending on the amount of PCl₃. In U.S. Pat. No. 6,255,416, a catalyst comprising Nd(versatate)₃, methylaluminoxane (MAO), Al(iBu)₂H, a metal halide and a Lewis base is used, and a tin compound and an isocyanate compound are used to control physical properties.

U.S. Pat. No. 7,247,695 discloses preparation of a polybutadiene-polyurethane copolymer using neodymium polybutadiene, an isocyanate compound, etc.

Polybutadiene prepared using a catalyst comprising a rare earth metal such as neodymium has superior physical properties because of its linear molecular structure. However, it has a storage problem because of cold flow. To solve this problem, U.S. Pat. No. 5,557,784 presents a method for controlling cold flow. In this patent, 1,4-cis-polybutadiene is prepared in a nonpolar solvent using a catalyst comprising a neodymium carboxylate compound, an alkylaluminum compound and a halogen containing compound. Then, after stopping the reaction using a reaction terminator and an antioxidant, sulfur chloride is added after removing unreacted 1,3-butadiene in order to reduce the odor caused by the addition of sulfur chloride.

As examples of preparation of high 1,4-cis-polybutadiene using nickel carboxylate, U.S. Pat. Nos. 6,013,746 and 6,562,917 disclose a method for preparing 1,4-cis-polybutadiene in a nonpolar solvent using a catalyst comprising (1) a nickel carboxylate compound, (2) a fluorine compound and (3) an alkylaluminum compound.

In a method disclosed in U.S. Pat. No. 3,170,905, a catalyst comprising at least one compound selected from a nickel carboxylate compound and an organonickel complex compound, at least one compound selected from a fluoroboron compound and a complex thereof, and at least one compound selected from an organometal compound of a group II or III metal and an alkali metal is used.

U.S. Pat. No. 3,725,492 discloses a method of preparing 1,4-cis-polybutadiene having a very small molecular weight from polymerization of 1,3-butadiene using a catalyst comprising a nickel compound, a halogen compound and an organoaluminum compound. In U.S. Pat. No. 6,727,330, nickel carboxylate and a polymerization terminator comprising an inorganic base and an amine compound or carboxylic acid is used to prevent gel formation during polymerization of butadiene using a catalyst comprising a fluoroboron compound and an organometal compound of an alkali metal.

In U.S. Pat. No. 4,129,538, an aromatic organosulfur compound is used to reduce rigidity and viscosity of natural rubber and synthetic butadiene-styrene rubber in order to provide better workability. Here, a halogenated sulfur compound, iron phthalocyanine, etc. are used as the aromatic organosulfur compound. By mixing rubber and the aromatic organosulfur compound in an open mill, it is possible to improve processability by reducing Mooney viscosity and to reduce work time. Specifically, for the aromatic organosulfur compound, pentachlorothiophenol, xylyl mercaptan, tetrachlorobenzenedithiol, mercaptobenzothiazole, dibenzoyl disulfide, dibenzamidodiphenyl disulfide, dibenzothiazyl disulfide, pentachlorophenyl disulfide, zinc pentachlorothiophenol, zinc xylyl mercaptan, zinc dibenzamidodiphenyl disulfide, and the like are used.

And, in U.S. Pat. No. 7,157,514, aromatic organosulfur compounds including the followings are presented: zinc bis(pentachlorothiophenol), fluorothiophenol, chlorothiophenol, bromothiophenol, iodothiophenol, difluorothiophenol, dichlorothiophenol, dibromothiophenol, diiodothiophenol, trifluorothiophenol, trichlorothiophenol, tribromothiophenol, triiodothiophenol, tetrafluorothiophenol, tetrachlorothiophenol, tetrabromothiophenol, tetraiodothiophenol, pentafluorothiophenol, pentachlorothiophenol, pentabromothiophenol, pentaiodothiophenol, bis(fluorophenyl) disulfide, bis(chlorophenyl) disulfide, bis(bromophenyl) disulfide, bis(iodophenyl) disulfide, bis(2-chloro-5-iodo) disulfide, bis(2-chloro-5-bromophenyl) disulfide, bis(2-chloro-5-fluoro) disulfide, bis(trifluorophenyl) disulfide, bis(trichlorophenyl) disulfide, bis(tribromophenyl) disulfide, bis(triiodophenyl) disulfide, bis(tetrafluorophenyl) disulfide, bis(tetrachlorophenyl) disulfide, bis(tetrabromophenyl) disulfide, bis(tetraiodophenyl) disulfide, bis(pentafluorophenyl) disulfide, bis(pentachlorophenyl) disulfide, bis(pentabromophenyl) disulfide, bis(pentaiodophenyl) disulfide, bis(acetylphenyl) disulfide, bis(3-aminophenyl) disulfide, tris(2,3,5,6-tetrachlorophenyl)methane, tris(2,3,5,6-tetrachloro-4-nitrophenyl)methane, di(pentachlorophenyl)phosphine chloride and di(pentafluorophenyl)phosphine chloride.

### SUMMARY OF THE INVENTION

The present invention has been made in an effort to solve the above-described problems associated with prior art. Accordingly, the present invention provides a golf ball core prepared from polybutadiene by adding a specific aromatic organosulfur compound improves flying performance and feel on hitting of a golf ball and enhances workability and processability of the golf ball manufacture due to decreased Mooney viscosity, and completed the present invention.

Accordingly, an object of the present invention is to provide 1,4-polybutadiene functionalized with an aromatic organosulfur compound for preparation of a golf ball core, prepared from a reaction of polybutadiene with a specific aromatic organosulfur compound and capable of considerably improving physical properties such as restitution, compression, viscosity, etc.

Another object of the present invention is to provide a composition for the preparation of a golf ball core comprising the 1,4-polybutadiene functionalized with an aromatic organosulfur compound, a metal salt of an unsaturated carboxylic acid, an inorganic filler and a peroxide.

The present invention provides 1,4-polybutadiene functionalized with an aromatic organosulfur compound, which is represented by Chemical Formula 1 and is used for preparation of a golf ball core:

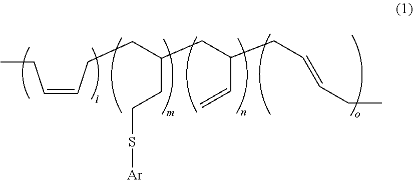

wherein l, m, n and o respectively represent the numbers of each repeat unit of the polybutadiene main chain, with 1 ranging from 50 to 99 wt %, m ranging from 0.05 to 5 wt %, n ranging from 0 to 49 wt %, o ranging from 0 to 49 wt %, and l+m+n+o=100 wt %, and S—Ar represents a substituent derived from an aromatic organosulfur compound; and

the aromatic organosulfur compound may be selected from fluorothiophenol, chlorothiophenol, bromothiophenol, iodothiophenol, difluorothiophenol, dichlorothiophenol, dibromothiophenol, diiodothiophenol, trifluorothiophenol, trichlorothiophenol, tribromothiophenol, triiodothiophenol, tetrafluorothiophenol, tetrachlorothiophenol, tetrabromothiophenol, tetraiodothiophenol, pentafluorothiophenol, pentachlorothiophenol, pentabromothiophenol, pentaiodothiophenol, fluorothiopyridine, chlorothiopyridine, bromothiopyridine, iodothiopyridine, difluorothiopyridine, dichlorothiopyridine, dibromothiopyridine, diiodothiopyridine, trifluorothiopyridine, trichlorothiopyridine, tribromothiopyridine, triiodothiopyridine, tetrafluorothiopyridine, tetrachlorothiopyridine, tetrabromothiopyridine, tetraiodothiopyridine, tetrachlorobenzenedithiol, mercaptobenzothiazole, tin dichlorooctaethylporphyrin, tin dichlorophthalocyanine, tin dichloronaphthalocyanine, tin dichlorooctabutoxyphthalocyanine glycidyl pentachlorothiophenyl ether, glycidyl pentafluorothiophenyl ether, dibenzamidodiphenyl disulfide and zinc pentachlorothiophenol.

The present invention further provides a composition for the preparation of a golf ball core, including: 100 parts by weight of the 1,4-cis-polybutadiene functionalized with an aromatic organosulfur compound; 5 to 50 parts by weight of a metal salt of an unsaturated carboxylic add; 1 to 60 parts by weight of an inorganic filler; and 0.1 to 5.0 parts by weight of a peroxide.

The 1,4-polybutadiene functionalized with an aromatic organosulfur compound according to the present invention may improve processability during preparation of a golf ball core by decreasing Mooney viscosity, and thus prepared golf ball core has improved feel on hitting and flying performance because of low compression and superior restitution.

### DESCRIPTION OF SPECIFIC EMBODIMENTS

The advantages, features and aspects of the invention will become apparent from the following description of the embodiments with reference to the accompanying drawings, which is set forth hereinafter.

The 1,4-polybutadiene functionalized with an aromatic organosulfur compound according to the present invention, which is used for preparation of a golf ball core, is represented by Chemical Formula 1:

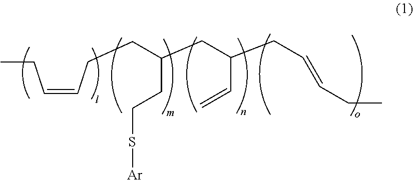

wherein l, m, n and o respectively represent the numbers of each repeat unit of the polybutadiene main chain, with 1 ranging from 50 to 99 wt %, m ranging from 0.05 to wt %, n ranging from 0 to 49 wt %, o ranging from 0 to 49 wt %, and l+m+n+o=100 wt %, and S—Ar represents a substituent derived from an aromatic organosulfur compound; and

the aromatic organosulfur compound is selected from fluorothiophenol, chlorothiophenol, bromothiophenol, iodothiophenol, difluorothiophenol, dichlorothiophenol, dibromothiophenol, diiodothiophenol, trifluorothiophenol, trichlorothiophenol, tribromothiophenol, triidodothiophenol, tetrafluorothiophenol, tetrachlorothiophenol, tetrabromothiophenol, tetraiodothiophenol, pentafluorothiophenol, pentachlorothiophenol, pentabromothiophenol, pentaiodothiophenol, fluorothiopyridine, chlorothiopyridine, bromothiopyridine, iodothiopyridine, difluorothiopyridine, dichlorothiopyridine, dibromothiopyridine, diiodothiopyridine, trifluorothiopyridine, trichlorothiopyridine, tribromothiopyridine, triiodothiopyridine, tetrafluorothiopyridine, tetrachlorothiopyridine, tetrabromothiopyridine, tetraiodothiopyridine, tetrachlorobenzenedithiol, mercaptobenzothiazole, tin dichlorooctaethylporphyrin, tin dichlorophthalocyanine, tin dichloronaphthalocyanine, tin dichlorooctabutoxyphthalocyanine glycidyl pentachlorothiophenyl ether, glycidyl pentafluorothiophenyl ether, dibenzamidodiphenyl disulfide and zinc pentachlorothiophenol.

The aromatic organosulfur compound may be one or more selected from fluorothiophenol, chlorothiophenol, bromothiophenol, iodothiophenol, difluorothiophenol, dichlorothiophenol, dibromothiophenol, diiodothiophenol, trifluorothiophenol, trichlorothiophenol, tribromothiophenol, triiodothiophenol, tetrafluorothiophenol, tetrachlorothiophenol, tetrabromothiophenol, tetraiodothiophenol, pentafluorothiophenol, pentachlorothiophenol, pentabromothiophenol, pentaiodothiophenol, fluorothiopyridine, chlorothiopyridine, bromothiopyridine, iodothiopyridine, difluorothiopyridine, dichlorothiopyridine, dibromothiopyridine, diiodothiopyridine, trifluorothiopyridine, trichlorothiopyridine, tribromothiopyridine, triiodothiopyridine, tetrafluorothiopyridine, tetrachlorothiopyridine, tetrabromothiopyridine, tetraiodothiopyridine, xylyl mercaptan, tetrachlorobenzenedithiol, mercaptobenzothiazole, tin dichlorooctaethylporphyrin, tin dichlorophthalocyanine, tin dichloronaphthalocyanine, tin dichlorooctabutoxyphthalocyanine glycidyl pentachlorothiophenyl ether, glycidyl pentafluorothiophenyl ether and dibenzamidodiphenyl disulfide, preferably one or more selected from pentachlorothiophenol, tetrachlorothiopyridine and 2,2′-diamidophenyldiphenyldisulfide.

The 1,4-polybutadiene functionalized with the aromatic organosulfur compound may be prepared easily by those skilled in the art from the disclosure of Korean Patent Publication No. 2009-0062154.

The 1,4-polybutadiene functionalized with the aromatic organosulfur compound has a cis content of 50 to 99% and a molecular weight of 100,000 to 2,000,000, preferably a cis content of 70 to 99% and a molecular weight of 200,000 to 1,000,000.

The present invention further provides a composition for the preparation of a golf ball core, comprising: 100 parts by weight of the 1,4-cis-polybutadiene functionalized with an aromatic organosulfur compound; 5 to 50 parts by weight of a metal salt of an unsaturated carboxylic acid; 1 to 60 parts by weight of an inorganic filler; and 0.1 to 5.0 parts by weight of a peroxide.

The metal salt of an unsaturated carboxylic acid controls rigidity during the crosslinking of the composition and may be an acrylate, methacrylate, diacrylate or dimethacrylate of a metal selected from magnesium, calcium, zinc, aluminum, sodium, lithium and nickel. The metal salt of an unsaturated carboxylic acid may be used in an amount of 5 to 50 parts by weight, preferably 10 to 40 parts by weight, based on 100 parts by weight of the 1,4-cis-polybutadiene functionalized with an aromatic organosulfur compound.

The inorganic filler is used to control the density of a golf ball core and may be any one capable of changing physical properties of the golf ball core. Preferably, one or more selected from zinc oxide, barium sulfate, calcium oxide and calcium carbonate may be used. The inorganic filler may be used in an amount of 1 to 60 parts by weight, preferably 0.5 to 50 parts by weight, based on 100 parts by weight of the 1,4-cis-polybutadiene functionalized with an aromatic organosulfur compound. The weight of the golf ball should not exceed 45.92 g, which is the upper limit determined by the United States Golf Association (USGA).

The peroxide serves as a crosslinking agent during the preparation of the golf ball core and may be any one or more selected from 1,1-bis(t-butylperoxy)-3,4,4,-trimethylcyclohexane, dicumyl peroxide, α,α-bis(t-butylperoxy)diisopropylbenzene, 2,5-dimethyl-2,5di(t-butylperoxy)hexane and di-t-butyl peroxide. The peroxide may be used in an amount of 0.1 to 5.0 parts by weight, preferably 0.5 to 3.0 parts by weight, based on 100 parts by weight of the 1,4-cis-polybutadiene functionalized with an aromatic organosulfur compound.

In addition, the composition for the preparation of a golf ball core may further include an antioxidant to prevent breakage of the core. The antioxidant may be, for example, a quinoline-based, amine-based or phenol-based antioxidant. Preferably, the antioxidant may be added in an amount of 0.1 to 2.0 parts by weight based on 100 parts by weight of the 1,4-cis-polybutadiene functionalized with an aromatic organosulfur compound.

### EXAMPLES

The examples and experiments will now be described. The following examples are for illustrative purposes only and not intended to limit the scope of the present invention.

### Preparation Examples 1 to 4

Neodymium versatate (1.0 wt % cyclohexane solution), diethylaluminum chloride (1.0 M cyclohexane solution), diisobutylaluminum hydride (15 wt % cyclohexane solution) and triisobutylaluminum (1.0 M cyclohexane solution) were used as Ziegler-Natta catalyst for polymerization of butadiene. The molar proportion of the catalysts was 1:3:4:20, and 1.0×10⁻⁴ mol of the neodymium catalyst was used per 100 g of the butadiene monomer.

After adding cyclohexane polymerization solvent (1.5 kg) and the catalyst to a 5 L polymerization reactor and then adding the butadiene monomer (300 g), reaction was performed at 70° C. for 2 hours.

Then, after adding pentachlorothiophenol dissolved in tetrahydrofuran (10 mL) as aromatic organosulfur compound such that the amount of pentachlorothiophenol was 0.05, 0.2, 0.25 and 0.5 part by weight based on 100 parts by weight of butadiene, the mixture was stirred at 100° C. for 1 hour. Then, 2,6-di-t-butyl-p-cresol (3.0 g) was added as antioxidant, and polyoxyethylene phosphate (1.2 g) and ethanol (10 mL) were added as reaction terminator to terminate the reaction.

### Preparation Examples 5 to 7

The procedure of Preparation Examples 1 to 4 was repeated, except that after adding 2,2′-diamidophenyldiphenyl disulfide dissolved in tetrahydrofuran (10 mL) as aromatic organosulfur compound, instead of pentachlorothiophenol, such that the amount of 2,2′-diamidophenyldiphenyl disulfide was 0.2, 0.25 and 0.5 part by weight based on 100 parts by weight of butadiene, the mixture was stirred at 100° C. for 1 hour.

### Preparation Examples 8 to 10

The procedure of Preparation Examples 1 to 4 was repeated, except that after adding tetrachlorothiopyridine dissolved in tetrahydrofuran (10 mL) as aromatic organosulfur compound, instead of pentachlorothiophenol, such that the amount of tetrachlorothiopyridine was 0.2, 0.25 and 0.5 part by weight based on 100 parts by weight of butadiene, the mixture was stirred at 100° C. for 1 hour.

### Preparation Example 11 to 12

The procedure of Preparation Examples 1 to 4 was repeated, except that after adding zinc pentachlorothiophenol dissolved in tetrahydrofuran (10 mL) as aromatic organosulfur compound, instead of pentachlorothiophenol, such that the amount of zinc pentachlorothiophenol was 0.2 and 0.5 part by weight based on 100 parts by weight of butadiene, the mixture was stirred at 100° C. for 1 hour.

### Preparation Example 13 to 16

The procedure of Preparation Examples 1 to 4 was repeated, except that after adding zinc tetrachlorothiopyridine dissolved in tetrahydrofuran (10 mL) as aromatic organosulfur compound, instead of pentachlorothiophenol, such that the amount of zinc tetrachlorothiopyridine was 00.3, 0.5, 0.7 and 1.0 part by weight based on 100 parts by weight of butadiene, the mixture was stirred at 100° C. for 1 hour.

### Comparative Preparation Example 1

Neodymium versatate (1.0 wt % cyclohexane solution), diethylaluminum chloride (1.0 M cyclohexane solution), diisobutylaluminum hydride (15 wt % cyclohexane solution) and triisobutylaluminum (1.0 M cyclohexane solution) were used as Ziegler-Natta catalyst for polymerization of butadiene. The molar proportion of the catalysts was 1:3:4:20, and 1.0×10⁻⁴ mol of the neodymium catalyst was used per 100 g of the butadiene monomer.

After adding cyclohexane polymerization solvent (1.5 kg) and the catalyst to a 5 L polymerization reactor and then adding the butadiene monomer (300 g), reaction was performed at 70° C. for 2 hours.

Then, 2,6-di-t-butyl-p-cresol (3.0 g) was added as antioxidant, and polyoxyethylene phosphate (1.2 g) and ethanol (10 mL) were added as reaction terminator to terminate the reaction.

### Comparative Preparation Example 2

Nickel naphthenate (1.0 wt % toluene solution), trimethylaluminum (1.0 M hexane solution) and trifluoroboron etherate (2 wt % toluene solution) were used as Ziegler-Natta catalyst for polymerization of butadiene. The molar proportion of the catalysts was 1:3:10, and 5.0×10⁻⁵ mol of the nickel catalyst was used per 100 g of the butadiene monomer.

After adding cyclohexane polymerization solvent (1.5 kg) and the catalyst to a 5 L polymerization reactor and then adding the butadiene monomer (300 g), reaction was performed at 70° C. for 2 hours.

Then, 2,6-di-t-butyl-p-cresol (3.0 g) was added as antioxidant, and polyoxyethylene phosphate (1.2 g) and ethanol (10 mL) were added as reaction terminator to terminate the reaction.

Physical properties of 1,4-polybutadienes obtained from Preparation Examples and Comparative Preparation Examples are given in Table 1.

In Table 1, average molecular weight was measured using a gel permeation chromatography (GPC) system (Shimadzu), and proportion of structural isomers was measured by the Moreno's method.

Mooney viscosity was measured as follows. Each 1,4-polybutadiene sample (30 g) was prepared into two test specimens (0.8 cm×5 cm×5 cm) using a roller. The specimen was attached at front and rear sides of a rotor and viscosity was measured using a rotary viscometer (Mooney MV2000, Alpha Technologies). After mounting the rotor on the rotary viscometer and preheating to 100° C. for 1 minute, the rotor was operated and change of viscosity of the solid rubber for 4 minutes was observed to determine the Mooney viscosityML₁₊₄ (100° C.).

TABLE 1

| | | Sulfur | Mooney | | | | | |
|---|---|---|---|---|---|---|---|---|
| | | compound | viscosity | | | | | |
| | Sulfur | content (parts | ML₁₊₄ | | | Cis | Vinyl | Trans |
| | compound | by weight) | (100° C.) | MW | MWD | (%) | (%) | (%) |
| Prep. | PCTP | 0.05 | 41.3 | 404,000 | 4.2 | 97.1 | 0.8 | 2.1 |
| Ex. 1 | | | | | | | | |
| Prep. | PCTP | 0.20 | 38.4 | 398,000 | 4.2 | 96.9 | 0.8 | 2.3 |
| Ex. 2 | | | | | | | | |
| Prep. | PCTP | 0.25 | 39.3 | 402,000 | 4.1 | 96.9 | 0.8 | 2.3 |
| Ex. 3 | | | | | | | | |
| Prep. | PCTP | 0.50 | 40.0 | 423,000 | 3.9 | 96.9 | 0.8 | 2.3 |
| Ex. 4 | | | | | | | | |
| Prep. | DBD | 0.20 | 55.7 | 461,000 | 3.9 | 97.0 | 0.8 | 2.2 |
| Ex. 5 | | | | | | | | |
| Prep. | DBD | 0.30 | 42.0 | 414,000 | 3.9 | 96.9 | 0.8 | 2.3 |
| Ex. 6 | | | | | | | | |
| Prep. | DBD | 0.50 | 70.9 | 511,000 | 4.1 | 96.9 | 0.8 | 2.3 |
| Ex. 7 | | | | | | | | |
| Prep. | TCTP | 0.20 | 41.6 | 380,000 | 3.8 | 96.8 | 0.8 | 2.4 |
| Ex. 8 | | | | | | | | |
| Prep. | TCTP | 0.25 | 39.0 | 380,000 | 3.6 | 97.0 | 0.9 | 2.1 |
| Ex. 9 | | | | | | | | |
| Prep. | TCTP | 0.50 | 33.1 | 417,000 | 3.8 | 96.7 | 0.7 | 2.6 |
| Ex. 10 | | | | | | | | |
| Prep. | Zn-PCTP | 0.20 | 40.3 | 406,000 | 3.8 | 96.5 | 0.8 | 2.7 |
| Ex. 11 | | | | | | | | |
| Prep. | Zn-PCTP | 0.50 | 40.0 | 408,000 | 3.9 | 96.7 | 0.8 | 2.5 |
| Ex. 12 | | | | | | | | |
| Prep. | Zn-TCTP | 0.30 | 40.3 | 401,000 | 4.1 | 96.7 | 0.8 | 2.5 |
| Ex. 13 | | | | | | | | |
| Prep. | Zn-TCTP | 0.50 | 40.6 | 413,000 | 4.1 | 97.1 | 0.8 | 2.1 |
| Ex. 14 | | | | | | | | |
| Prep. | Zn-TCTP | 0.70 | 41.0 | 387,000 | 4.1 | 96.5 | 0.8 | 2.7 |
| Ex. 15 | | | | | | | | |
| Prep. | Zn-TCTP | 1.00 | 41.0 | 399,000 | 4.2 | 96.8 | 1.1 | 2.1 |
| Ex. 16 | | | | | | | | |
| Comp. | — | — | 43.5 | 387,000 | 3.2 | 97.6 | 0.8 | 1.6 |
| Prep. | | | | | | | | |
| Ex. 1 | | | | | | | | |
| Comp. | — | — | 42.6 | 400,000 | 4.2 | 96.3 | 1.8 | 1.9 |
| Prep. | | | | | | | | |
| Ex. 2 | | | | | | | | |

PCTP: pentachlorothiophenol
DBD: 2,2′-diamidophenyldiphenyl disulfide
TCTP: tetrachlorothiopyridine
Zn-PCTP: zinc pentachlorothiophenol
Zn-TCTP: zinc tetrachlorothiopyridine

### Examples 1 to 16 and Comparative Examples 1 to 3

The 1,4-polybutadiene functionalized with an aromatic organosulfur compound (300 g) prepared in Preparation Examples was put in a Banbury mixer (Mix-Labo, Moriyama) and, after premixing for 1 minute, zinc diacrylate (60 g) was added and mixed for 10 minutes. Then, zinc oxide (90 g) and 1,1-bis(t-butylperoxy)-3,4,4-trimethylcyclohexane (6 g) were added and mixed for 5 minutes. The Banbury mixer condition was 50 rpm and inside temperature 50° C. The contents of the components used to prepare a golf ball core are shown in Table 2.

TABLE 2

| Components | Contents (g) |
|---|---|
| 1,4-Polybutadiene functionalized with organosulfur | 300 |
| compound | |
| Zinc diacrylate (ZDA) | 60 |
| Zinc oxide (ZnO) | 90 |
| Peroxide (1,1-bis(t-butylperoxy)-3,4,4- | 6 |
| trimethylcyclohexane) | |

The resultant blend was immediately wound at least 10 times using a roll mill (100° C.), and thus prepared sheet was aged for 24 hours after being sealed.

Then, the sheet was rolled into a cylindrical shape using a roll mill preheated to 60° C. and cut to a weight (36.5 g) fit for a press mold. The cut specimen was put in the mold and prepared into a golf ball core by hot pressing at 170° C. The prepared golf ball core was allowed to cool spontaneously, and then Mooney viscosity, coefficient of restitution and compression were measured.

Coefficient of restitution is measured to estimate energy loss of the golf ball core specimen upon impact. The coefficient of restitution is 1.000 in case of perfectly elastic collision and is 0.000 in case of perfectly inelastic collision. The coefficient of restitution was measured down to three decimal places. The USGA places the limit of restitution of golf balls between 0.830 and 0.780. Usually, improvement of flying performance is measured by the increase of coefficient of restitution in the golf ball manufacturing industry. Velocigraph (Automated Design Corporation) was used to measure the coefficient of restitution.

The velocity of a projected golf ball is measured by a laser sensor while the ball passes through a distance of 12 inches over the device, and the velocity of the ball bouncing backward is measured while it passes again through the distance of 12 inches. The coefficient of restitution is given by the following Equation 1.

Coefficient of restitution=(V_{2f}−V_{1f})/(V₁−V₂) (1)

V₁: velocity of a projected ball measured by a first laser sensor before collision

V₂: velocity of the projected ball measured by a second laser sensor before collision

V_{2f}: velocity of a bouncing ball measured by the first laser sensor after collision

V_{1f}: velocity of the bouncing ball measured by the second laser sensor after collision

Compression is measured as follows. The golf ball core specimen is placed between fixed presses. When both the upper and lower presses are in contact with the specimen, the force (kgf/cm²) required to press the specimen by 0.2 mm is measured. Usually, in the golf ball manufacturing industry, hardness of a golf ball is denoted by the compression. Compression Set Tester (Daekyung Engineering) was used for the measurement of compression.

Physical property measurement results are given in Table 3.

TABLE 3

| | | Sulfur | | | | | |
|---|---|---|---|---|---|---|---|
| | | compound | Mooney | | | | |
| | | content | viscosity | | | | |
| | Sulfur | (parts by | ML₁₊₄ | Diameter | Weight | | |
| Polybutadiene | compound | weight) | (100° C.) | (mm) | (g) | Compression | Restitution |
| Ex. 1 | PCTP | 0.05 | 35.6 | 39.0 | 36.0 | 41.3 | 0.805 |
| Ex. 2 | PCTP | 0.20 | 38.0 | 38.8 | 36.1 | 38.0 | 0.804 |
| Ex. 3 | PCTP | 0.25 | 35.4 | 38.9 | 36.1 | 40.8 | 0.803 |
| Ex. 4 | PCTP | 0.50 | 38.2 | 39.0 | 36.0 | 32.6 | 0.805 |
| Ex. 5 | DBD | 0.20 | 40.1 | 39.0 | 36.0 | 48.0 | 0.804 |
| Ex. 6 | DBD | 0.30 | 42.9 | 38.9 | 35.9 | 41.9 | 0.802 |
| Ex. 7 | DBD | 0.50 | 49.5 | 38.9 | 35.9 | 44.0 | 0.800 |
| Ex. 8 | TCTP | 0.20 | 36.3 | 38.9 | 36.0 | 41.6 | 0.807 |
| Ex. 9 | TCTP | 0.25 | 35.4 | 38.9 | 36.0 | 44.8 | 0.803 |
| Ex. 10 | TCTP | 0.50 | 27.4 | 38.8 | 36.0 | 42.3 | 0.803 |
| Ex. 11 | Zn- | 0.20 | 53.4 | 39.0 | 35.9 | 40.3 | 0.800 |
| | PCTP | | | | | | |
| Ex. 12 | Zn- | 0.50 | 46.2 | 38.9 | 35.9 | 40.0 | 0.807 |
| | PCTP | | | | | | |
| Ex. 13 | Zn- | 0.30 | 42.4 | 39.0 | 36.0 | 40.0 | 0.800 |
| | TCTP | | | | | | |
| Ex. 14 | Zn- | 0.50 | 37.7 | 38.9 | 35.9 | 41.2 | 0.803 |
| | TCTP | | | | | | |
| Ex. 15 | Zn- | 0.70 | 37.3 | 38.9 | 36.0 | 35.9 | 0.807 |
| | TCTP | | | | | | |
| Ex. 16 | Zn- | 1.00 | 37.3 | 38.9 | 35.8 | 34.6 | 0.805 |
| | TCTP | | | | | | |
| Comp. Ex. 1 | — | — | 39.0 | 39.0 | 36.0 | 52.0 | 0.794 |
| Comp. Ex. 2 | — | — | 41.2 | 39.0 | 36.1 | 53.4 | 0.784 |

As seen in Table 3, the golf ball cores of Examples show lower compression but higher coefficient of restitution as compared to those of Comparative Examples. Therefore, they may improve flying performance and feel on hitting of golf balls.

While the present invention has been described with respect to the specific embodiments, it will be apparent to those skilled in the art that various changes and modifications may be made without departing from the spirit and scope of the invention as defined in the following claims.

1. 1,4-Cis-polybutadiene functionalized with an aromatic organosulfur compound, which is represented by Chemical Formula 1 and is used for preparation of a golf ball core: 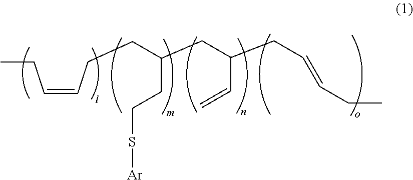
wherein
l, m, n and o respectively represent the numbers of each repeat unit of the polybutadiene main chain, with 1 ranging from 50 to 99 wt %, m ranging from 0.05 to 5 wt %, n ranging from 0 to 49 wt %, o ranging from 0 to 49 wt %, and l+m+n+o=100 wt %, and S—Ar represents a substituent derived from an aromatic organosulfur compound; and
the aromatic organosulfur compound is selected from fluorothiophenol, chlorothiophenol, bromothiophenol, iodothiophenol, difluorothiophenol, dichlorothiophenol, dibromothiophenol, diiodothiophenol, trifluorothiophenol, trichlorothiophenol, tribromothiophenol, triiodothiophenol, tetrafluorothiophenol, tetrachlorothiophenol, tetrabromothiophenol, tetraiodothiophenol, pentafluorothiophenol, pentachlorothiophenol, pentabromothiophenol, pentaiodothiophenol, fluorothiopyridine, chlorothiopyridine, bromothiopyridine, iodothiopyridine, difluorothiopyridine, dichlorothiopyridine, dibromothiopyridine, diiodothiopyridine, trifluorothiopyridine, trichlorothiopyridine, tribromothiopyridine, triiodothiopyridine, tetrafluorothiopyridine, tetrachlorothiopyridine, tetrabromothiopyridine, tetraiodothiopyridine, tetrachlorobenzenedithiol, mercaptobenzothiazole, tin dichlorooctaethylporphyrin, tin dichlorophthalocyanine, tin dichloronaphthalocyanine, tin dichlorooctabutoxyphthalocyanine glycidyl pentachlorothiophenyl ether, glycidyl pentafluorothiophenyl ether, dibenzamidodiphenyl disulfide and zinc pentachlorothiophenol.

2. The 1,4-cis-polybutadiene according to claim 1, wherein the aromatic organosulfur compound is comprised in an amount of 0.05 to 5 parts by weight based on 100 parts by weight of the 1,4-cis-polybutadiene.

3. The 1,4-cis-polybutadiene according to claim 1, wherein the 1,4-cis-polybutadiene has a cis content of 50 to 99% and a molecular weight of 100,000 to 2,000,000.

4. A composition for the preparation of a golf ball core, comprising:
100 parts by weight of the 1,4-cis-polybutadiene functionalized with an aromatic organosulfur compound according to claims 1;
5 to 50 parts by weight of a metal salt of an unsaturated carboxylic acid;
1 to 60 parts by weight of an inorganic filler; and
0.1 to 5.0 parts by weight of a peroxide.

5. The composition for the preparation of a golf ball core according to claim 4, wherein the metal salt of an unsaturated carboxylic acid is an acrylate, methacrylate, diacrylate or dimethacrylate of a metal selected from magnesium, calcium, zinc, aluminum, sodium, lithium and nickel.

6. The composition for the preparation of a golf ball core according to claim 4, wherein the inorganic filler is one or more selected from barium sulfate, calcium oxide and calcium carbonate.

7. The composition for the preparation of a golf ball core according to claim 4, wherein the peroxide is one or more selected from 1,1-bis(t-butylperoxy)-3,4,4,-trimethylcyclohexane, dicumyl peroxide, α,α-bis(t-butylperoxy)diisopropylbenzene, 2,5-dimethyl-2,5di(t-butylperoxy)hexane and di-t-butyl peroxide.

8. A composition for the preparation of a golf ball core, comprising:
100 parts by weight of the 1,4-cis-polybutadiene functionalized with an aromatic organosulfur compound according to claim 2;
5 to 50 parts by weight of a metal salt of an unsaturated carboxylic acid;
1 to 60 parts by weight of an inorganic filler; and
0.1 to 5.0 parts by weight of a peroxide.

9. A composition for the preparation of a golf ball core, comprising:
100 parts by weight of the 1,4-cis-polybutadiene functionalized with an aromatic organosulfur compound according to claims 3;
5 to 50 parts by weight of a metal salt of an unsaturated carboxylic acid;
1 to 60 parts by weight of an inorganic filler; and
0.1 to 5.0 parts by weight of a peroxide.
